(19) United States
(12) Patent Application Publication
(10) Pub. No.: US 2006/0216479 A1
(43) Pub. Date: Sep. 28, 2006

(54) TWO-SHOT, CO-INJECTED TRIM PANEL

(75) Inventors: Glenn A. Cowelchuk, Chesterfield Township, MI (US); Michael P. Schoemann, Waterford, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/907,146

(22) Filed: Mar. 22, 2005

(51) Int. Cl. B32B 1/00

(52) U.S. Cl. 428/174; 425/573; 264/255

(57) ABSTRACT

In at least certain embodiments, the present invention relates to a method of making an interior trim panel, a mold for forming the interior trim panel, and the interior trim panel. In at least one embodiment, the vehicle trim panel comprises a substrate portion comprising a substrate shell layer and a substrate core layer substantially disposed within the substrate shell layer, and a padded cover portion integrally molded onto at least a portion of the substrate portion, with the padded cover portion comprising a cover shell layer and a cover core layer substantially disposed within the cover shell layer.

### BACKGROUND OF THE INVENTION

1. Field of the Invention

The present invention relates to a method of making an interior trim panel, a mold for forming the interior trim panel, and the interior trim panel.

2. Background Art

Motor vehicle interiors have many interior components made of trim panels. Examples of these types of interior components include, but are not necessarily limited to, interior trim panels, interior door panels, knee bolsters, instrument panel, consoles, other interior trim parts and seats.

Vehicle trim panels typically comprise a rigid retainer or substrate panel and a thin elastic plastic skin covering the panel. For some panels where a softer touch is desired, foam has been provided between the substrate and the skin. For these types of panels, a foam in place process is often times used to provide the foam. In this type of process, the skin and the substrate are positioned spaced apart in a mold while foam is molded there between. After the foam is molded, the foam extends between and secures the skin to the substrate. While the presence of foam is necessary for these types of panels, the use of a foam in place process adds another manufacturing step, and costs associated with that step, to the manufacture of these trim panels.

Furthermore, there are occasions where trim panels having a soft feel are desired but because of design constraints are not easily manufacturable. One example is of a door panel having a soft feel above the arm rest to match the appearance and feel of the instrument panel. Another example is of a trim panel, such as a door panel or instrument panel, that has undercuts, sharp radii, or other design configuration that results in relatively small, or somewhat significantly uneven, clearances between the skin and the substrate. In these, and other, types of designs, foam in place may have drawbacks that could prevent such a technique from being a suitable option.

Additionally, a relatively common construction of trim panels is for the substrate to have portions that are adjacent the cover skin. This reduces the amount of cover skin that is required to be used. However, in these types of trim panels, the substrate is typically made with a material that will provide a high quality surface finish (an “A” surface) since this portions of the substrate adjacent the cover skin will be exposed to the vehicle compartment interior.

Materials that are capable of providing an “A” surface are typically more expensive than materials that are not capable of providing an “A” surface. The increase in cost of “A” surface materials relative to non-“A” surface materials can be due to use of additives such as colorant, gloss agents, surface hardness agents, impact modifiers, UV inhibitors, and flame retardant in the “A” surface material, which is not required in the non-“A” surface material and/or to the lack of materials in the “A” surface material, such as fillers, talc, glass, recycled and/or reground polymer, off-spec material, and blowing agents that are present in the non-“A” surface materials.

Additionally, sometimes material additives are needed to achieve a desired physical property of a surface area of a panel and/or of a panel itself. Certain of these additives include glass, impact modifiers, nanocomposites, blowing agents and talc. The use of these additives can sometimes add cost and/or interfere with the desired properties, such as surface properties, of the “A” surface.

These and other problems and disadvantages are addressed by Applicants' invention as summarized below.

### SUMMARY OF THE INVENTION

According to one aspect of the present invention, a method of making an interior trim panel for a vehicle is provided. In at least one embodiment, the method comprises co-injecting a first material and a second material into a first injection mold cavity defining the shape of a substrate portion of the trim panel to form the substrate portion, and co-injecting a third material and a fourth material into a second injection mold cavity containing the substrate portion and defining the shape of a padded cover portion of the trim panel to form the padded cover portion integrally molded onto at least a portion of the substrate portion.

In accordance with at least another aspect of the present invention, the substrate portion comprises a substrate shell layer and a substrate core layer substantially disposed within the substrate shell layer and the cover portion comprises a cover shell layer and a cover core layer substantially disposed within the cover shell layer.

In accordance with at least yet another aspect of the present invention, the substrate shell layer is made of the first material, the substrate core layer is made of the second material, the cover shell layer is made of the third material, and the cover core layer is made of the fourth material.

According to another aspect of the present invention, a mold for forming a trim panel of a vehicle is provided. In at least one embodiment, the mold comprises a first injection mold having a first mold portion and a second mold portion capable of relative movement between an open position and a closed position. In at least this embodiment, the first and second mold portions, when in the closed position, define a first cavity in which the shape of a substrate portion of the trim panel is defined. In at least this embodiment, at least one of the first and second mold portions has at least one port for co-injecting a first polymeric material and a second polymeric material into the first cavity to form the substrate portion. In at least this embodiment, the mold further comprises a second injection mold including the first mold portion of the first injection mold and a third mold portion capable of relative movement between an open position and a closed position in which the substrate portion is supported within the second injection mold. In at least this embodiment, the first and third mold portions, when in the closed position and when the substrate portion is supported within the second injection mold, define a second cavity in which the shape of a padded cover portion of the trim panel portion is defined. In at least this embodiment, at least one of the first and third mold portions has at least one port for co-injecting a third polymeric material and a fourth polymeric material into the second cavity to form the padded cover portion integrally molded onto at least a portion of the substrate portion.

According to another aspect of the present invention, a vehicle trim panel is provided. In at least one embodiment, the trim panel comprises a substrate portion comprising a substrate shell layer and a substrate core layer substantially disposed within the substrate shell layer, and a padded cover portion integrally molded onto at least a portion of the substrate portion. In at least this embodiment, the padded cover portion comprises a cover shell layer and a cover core layer substantially disposed within the cover shell layer.

In accordance with at least another aspect of the invention, the substrate shell layer is formed of a first material and the substrate core layer is formed of a second material.

In accordance with at least another aspect of the invention, the second material is less costly than the first material.

In accordance and with at least another aspect of the invention, the second material has a lower hardness than the first material.

In accordance with at least another aspect of the invention, the substrate shell layer is of a first color and the substrate core layer is of a second color.

In accordance with at least another aspect of the invention, the cover shell layer is formed of a third material and the cover core layer is formed of a fourth material.

In accordance with least another aspect of the invention, the substrate portion is 1-6 mm thick and the substrate core layer comprises 20-80% of the thickness of the substrate member.

In accordance with at least another aspect of the invention, the cover portion is 1-20 mm thick and the cover core layer comprises 80-20% of the thickness of the substrate member.

In accordance with at least another aspect of the invention, the substrate shell layer has a higher surface quality than the substrate core layer.

In accordance with at least another aspect of the invention, the cover shell layer has a higher surface quality than the cover core layer.

These and other aspects of the present invention will be better understood with reference to the attached drawings and the following detailed description of a preferred embodiment of the invention.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

The invention will now be described in greater detail in the following way of example only and with reference to the attached drawings, in which:

FIG. 1 is a schematic perspective view of an instrument panel manufactured in accordance with the present invention;

FIG. 2 is a cross-sectional view showing an interior trim panel formed in accordance with the present invention;

FIG. 3 is a cross-sectional view of a molding tool for forming a substrate portion of the interior trim panel;

FIG. 4 is a cross-sectional view of a molding tool for forming a padded cover portion of the interior trim panel; and

FIG. 5 is a cross-sectional view of a mold for forming the padded portion of the interior trim component at the completion of the molding cycle.

### DETAILED DESCRIPTION OF THE PREFERRED EMBODIMENTS

As required, detailed embodiments of the present invention are disclosed herein. However, it is to be understood that disclosed embodiments are merely exemplary of the invention that may be embodied in various alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims indicating amounts of materials or conditions of reactions and/or use are to be understood as modified by the word “about” in describing the broadest scope of this invention. Practice within the numeral limit stated is generally preferred. Also, unless expressly stated to the contrary, percent, “parts of,” and ratio values are by weight and the description of a group or class of materials as suitable or preferred for a given purpose in connection with the invention implies that mixtures of any two or more members of the group or class may be equally suitable or preferred.

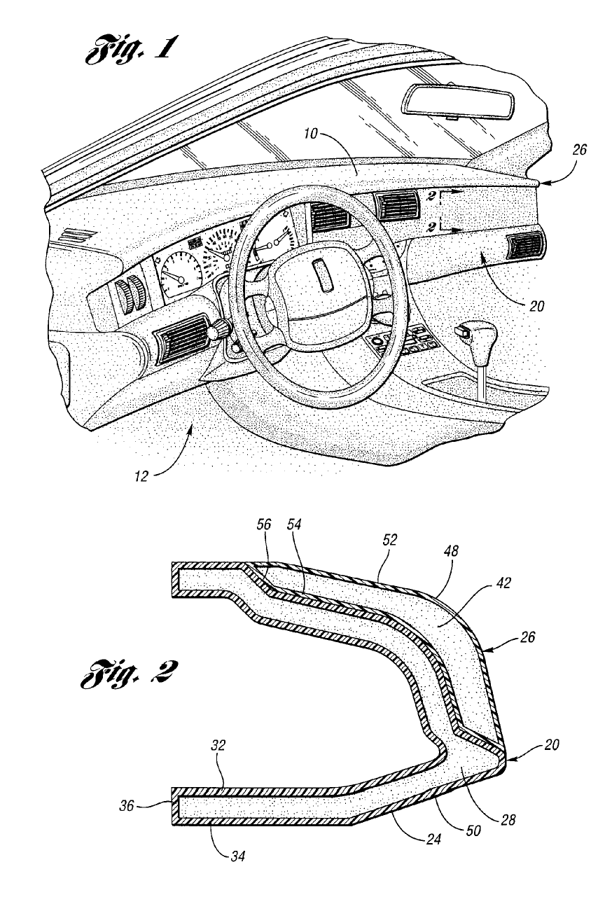

FIGS. 1 and 2 show an interior vehicle trim component, such as an instrument panel 10, in accordance with at least one aspect of the invention, for use within a motor vehicle 12. Certain aspects of the present invention will be described below in connection with the instrument panel 10. However, it should be understood that other trim products, such as door panels, door covers, glove box consoles, glove box console covers, consoles, console covers, pillar trim panels, shelves, trim covers and the like can also enjoy the benefits of the present invention.

As shown in FIGS. 1-2, in at least one embodiment, the instrument panel 10 includes a rigid substrate portion 20, and a padded cover portion 26 that covers a portion of the substrate portion and provides an exterior appearance surface.

The substrate portion 20 is a structural member that provides support for the remainder of the instrument panel 10. In the illustrated embodiment, the substrate portion 20 comprises a shell layer 24 and a core layer 28 at least substantially disposed in the shell layer 24. As shown in FIG. 2, the core layer 28 is disposed entirely within the shell layer 24, however, it is contemplated that some portion of the core layer 28 may extend external to the shell layer 24.

In at least one embodiment, the substrate portion 20 is between 1-6 mm thick, and in at least another embodiment between 2-4 mm. In at least one embodiment, the core layer 28 of the substrate portion 20 comprises 20-80% of the thickness of the substrate portion, in other embodiments between 30 and 70%, and in yet other embodiments between 40 and 60%. In at least the illustrated embodiment, the shell layer 24 is defined by an upper wall 32, a spaced-apart lower wall 34, and a sidewall 36 extending between and connecting the upper and lower walls. In at least one embodiment, each of the upper and lower walls 32 and 34 comprises between 10 and 40% of the thickness of the substrate portion 20, in at least another embodiment between 15 and 35% of the thickness, and yet in other embodiments between 20 and 30%.

In at least one embodiment, the core layer 28 and the shell layer 24 of the substrate portion 20 are made of different materials. Examples of suitable materials to make the substrate portion 20 include, but are not limited to, thermoplastic elastomer, thermoplastic elastomer polyolefin, polycarbonate, polypropylenes, ABS (acrylonitrile butadiene styrene), polycarbonate ABS, SMA (styrene maleic anhydride), polyphenyloxide (PPO), nylon, polyester, acrylic, thermoplastic olefin (TPO), and polysulfone.

In at least one embodiment, the core layer 28 can be made of a material that is less costly than the material that is used to make the shell layer 24. The difference in cost between the materials used to make the shell layer 24 and the core layer 28 of the substrate portion 20 can be attributed to the fact that the shell layer may have portions, such as 50, that are exposed to the vehicle occupant and thus are required to be an “A” surface. For instance, the shell layer 24 may be required to have a colored appearance, a hardness of at least a certain value, a gloss level of at least a certain value which are not required of the core layer 28 since the core layer 28 will not have portions exposed within the vehicle compartment. As such, the material used to make the core layer 28 can have at least one or more of a lower hardness, lower gloss, or less aesthetically pleasing color than the material used to make the shell layer 24 of the substrate portion 20. Additionally, the material used to make the shell layer 24 may have one or more additives, such as UV stabilizer, heat component, flame retardant, coolant, gloss agent, surface hardness agent, and impact modifiers, that the material used to make the core layer 28 does not have.

In at least another embodiment, the core layer 28 can be made of a material yielding a different physical property than the material used to make the shell layer 24. For instance, the material used to make the core layer 28 can be a lower or higher density material than the shell layer 24 material and/or a filled material, such as with glass, talc, nanocomposites, and/or a material having at least some reground polymeric material, and/or have impact modifiers and/or some other hardness modifier such as a blowing or foaming agent.

In at least one embodiment, the material used to form the shell layer 24 of the substrate portion 20 comprises a relatively virgin material and in another embodiment a relatively virgin material having a color imparted to it, such as black blue, gray, beige, and red thermoplastic olefin.

In at least one embodiment, the material used to form the core layer 28 can comprise an uncolored, natural polymeric material, such as natural thermoplastic polyolefin, which is typically a natural, non-aesthetically pleasing color. In at least another embodiment, the core layer 28 of the substrate portion 20 can be formed of a material that is made from 30-100% regrind polymeric material or filled, such as with talc or glass, polymeric material.

The padded cover portion 26 is a padded area that provides a soft touch to the trim panel 10. In the illustrated embodiment, the padded cover portion 26 comprises a shell layer 48 and a core layer 42 at least substantially disposed in the shell layer 48. As shown in FIG. 2, the core layer 42 of the padded cover portion 26 is disposed entirely within the shell layer 48, however, it is contemplated that some portion of the core layer 42 may extend external to the shell layer 48.

In at least one embodiment, the padded cover portion 26 is between 1-20 mm thick, and in at least another embodiment between 1.5 to 8 mm. In at least one embodiment, the core layer 42 of the padded cover portion 26 comprises 20 to 80% of the thickness of the padded cover portion, in other embodiments between 30 and 70%, and in yet other embodiments between 40 and 60%. In at least the illustrated embodiment, the shell layer 48 is defined by an upper wall 52, a spaced-apart lower wall 54, and a sidewall 56 extending between and connecting the upper and lower walls. In at least one embodiment, each of the upper and lower walls 52 and 54 comprises between 10 and 40% of the thickness of the padded cover portion 26, in at least another embodiment between 15 and 35% of the thickness, and yet in other embodiments between 20 and 30%.

In at least one embodiment, the core layer 42 and the shell layer 48 of the padded cover portion 26 are made of different materials. Examples of suitable materials to make the padded cover portion 26 include, but are not limited to, thermoplastic elastomer, thermoplastic elastomer polyolefin, polycarbonate, polypropylenes, ABS (acrylonitrile butadiene styrene), polycarbonate ABS, SMA (styrene maleic anhydride), polyphenyloxide (PPO), nylon, polyester, acrylic, thermoplastic olefin (TPO), and polysulfone.

In at least one embodiment, the core layer 42 of the padded cover portion 26 can be made of a material that is less costly than the material that is used to make the shell layer 48 of the padded cover portion 26. The difference in cost between the materials used to make the shell layer 48 and the core layer 42 of the padded cover portion 26 can be attributed to the fact that the shell layer may have portions that are exposed to the vehicle occupant and thus are required to be an “A” surface. For instance, the shell layer 48 may be required to have a colored appearance, a hardness of at least a certain value, a gloss level of at least a certain value which are not required of the core layer 42 since the core layer 42 will not have portions exposed within the vehicle compartment. As such, the material used to make the core layer 42 can have at least one or more of a lower hardness, lower gloss, or less aesthetically pleasing color than the material used to make the shell layer 48 of the padded cover portion 26. Additionally, the material used to make the shell layer 48 may have one or more additives, such as UV stabilizer, heat component, flame retardant, coolant, gloss agent, surface hardness agent, and impact modifiers, that the material used to make the core layer 42 does not have.

In at least another embodiment, the core layer 42 can be made of a material yielding a different physical property than the material used to make the shell layer 48. For instance, the material used to make the core layer 42 can be a lower or higher density material than the shell layer 48 material, and/or a filled material, such as with glass, talc, nanocomposites, and/or a material having at least some reground polymeric material, and/or have impact modifiers and/or some other hardness modifier such as a blowing or foaming agent.

In at least one embodiment, the material used to form the shell layer 48 of the padded cover portion 26 comprises a relatively virgin material, such as a polymeric material having a 50-85 shore A hardness, and in another embodiment a relatively virgin material having a color imparted to it, such as black thermoplastic elastomer having a 50-85 shore A hardness.

In at least one embodiment, the material used to form the core layer 42 can comprise an uncolored, natural polymeric material, having a 5-25 shore A hardness, and in another embodiment, a natural thermoplastic elastomer, having a natural color and a 5-25 shore A hardness. In at least another embodiment, the core layer 42 of the padded cover portion 26 can be formed of a foamed or relatively low density material.

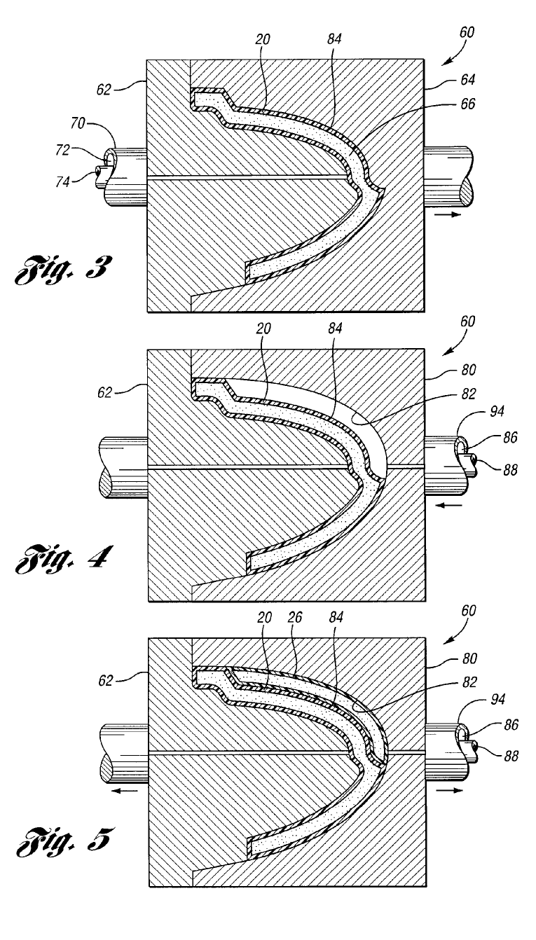

Referring to FIG. 3, a molding tool 60 is shown that comprises a first mold part 62 and a second mold part 64. The first mold part 62 and second mold part 64 form a substrate portion mold cavity 66. The first mold part 62 includes at least one sprue member 70 having first and second annular sprues 72, 74, whereby first and second materials, different from each other, may be co-injected into cavity 66 to form the substrate portion 20.

The substrate portion 20 of instrument panel 10 is formed during the first shot of a two-shot co-injection molding operation by co-injecting the first and second materials into the mold 60 configured to form the substrate portion 20. In the embodiment shown, mold 60 comprises the first and second halves 62, 64 which may be assembled together to define the interior cavity 66 having the general shape of the substrate portion 20. The first and second materials are injected into the cavity 66 through the sprue 70 as known in the art to form the substrate portion 20.

Referring to FIG. 4, after the first and second materials have been injected into the mold 60 to form the substrate portion 20, the second mold portion 64 is removed and replaced with a third mold portion 80 which is configured such that the first and third mold portions 62, 80 define a cavity 82 for forming the padded cover portion 26 during the second shot of the two-shot mold process. As seen in FIGS. 4 and 5, the substrate portion 20 is retained in the mold 60 so that the padded cover portion 26 may be formed directly on the target area 84 during the second shot of the molding operation.

Referring to FIGS. 4 and 5, the molded substrate portion 20 is shown on the first mold part 62. A third mold part 80 is shown engaging the first mold part 62. The third mold part 80 includes at least one sprue member 94 having first and second annular sprues 86, 88, whereby first and second materials, different from each other, may be co-injected into cavity 82 to form the padded cover portion 26.

Depending upon part geometry, part size, and material selection, the temperature and pressure are determined. Typically, the materials would be heated to between 200° F. and 650° F. at pressures of between 500 and 40,000 psi. The mold parts may be cooled by circulating water or air cooled as is well known in the art.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an interior trim panel for a vehicle comprising:
co-injecting a first material and a second material into a first injection mold cavity defining the shape of a substrate portion of the trim panel to form the substrate portion; and
co-injecting a third material and a fourth material into a second injection mold cavity containing the substrate portion and defining the shape of a padded cover portion of the trim panel to form the padded cover portion integrally molded onto at least a portion of the substrate portion.

2. The method of claim 1, wherein the substrate portion comprising a substrate shell layer and a substrate core layer substantially disposed within the substrate shell layer and the cover portion comprising a cover shell layer and a cover core layer substantially disposed within the cover shell layer.

3. The method of claim 2, wherein the substrate shell layer is made of the first material, the substrate core layer is made of the second material, the cover shell layer is made of the third material, and the cover core layer is made of the fourth material.

4. The method of claim 1, wherein the second material has a lower hardness than the first material.

5. The method of claim 1, wherein the fourth material has a lower density than the third material.

6. A mold for forming a trim panel of a vehicle comprising:
a first injection mold having a first mold portion and a second mold portion capable of relative movement between an open position and a closed position, the first and second mold portions, when in the closed position, defining a first cavity in which the shape of a substrate portion of the trim panel is defined, at least one of the first and second mold portions having at least one port for co-injecting a first polymeric material and a second polymeric material into the first cavity to form the substrate portion; and
a second injection mold including the first mold portion of the first injection mold and a third mold portion capable of relative movement between an open position and a closed position in which the substrate portion is supported within the second injection mold, the first and third mold portions, when in the closed position and when the substrate portion is supported within the second injection mold, defining a second cavity in which the shape of a padded cover portion of the trim panel portion is defined, at least one of the first and third mold portions having at least one port for co-injecting a third polymeric material and a fourth polymeric material into the second cavity to form the padded cover portion integrally molded onto at least a portion of the substrate portion.

7. The mold of claim 6, wherein the substrate portion comprising a substrate shell layer and a substrate core layer substantially disposed within the substrate shell layer and the cover portion comprising a cover shell layer and a cover core layer substantially disposed within the cover shell layer.

8. The mold of claim 7, wherein the substrate shell layer is made of the first material, the substrate core layer is made of the second material, the cover shell layer is made of the third material, and the cover core layer is made of the fourth material.

9. The mold of claim 8, wherein the second material has a lower hardness than the first material and the fourth material has a lower density than the third material.

10. A vehicle trim panel, comprising:
a substrate portion comprising a substrate shell layer and a substrate core layer substantially disposed within the substrate shell layer; and
a padded cover portion integrally molded onto at least a portion of the substrate portion, the padded cover portion comprising a cover shell layer and a cover core layer substantially disposed within the cover shell layer.

11. The vehicle trim panel of claim 10, wherein the substrate shell layer is formed of a first material and the substrate core layer is formed of a second material.

12. The vehicle trim panel of claim 11, wherein the second material is less costly than the first material.

13. The vehicle trim panel of claim 11, wherein the second material has a lower hardness than the first material.

14. The vehicle trim panel of claim 10, wherein substrate shell layer is of a first color and the substrate core layer is of a second color.

15. The vehicle trim panel of claim 11, wherein the second material has a higher hardness than the first material.

16. The vehicle trim panel of claim 10, wherein the cover shell layer is formed of a third material and the cover core layer is formed of a fourth material.

17. The vehicle trim panel of claim 10, wherein the substrate portion is 2-4 mm thick with the substrate core layer comprising 20-80% of the thickness of the substrate member.

18. The vehicle trim panel of claim 17, wherein the cover portion is 1.5-8 mm thick with the cover core layer comprising 80-20% of the thickness of the substrate member.

19. The vehicle trim panel of claim 10, wherein substrate shell layer has a higher surface quality than the substrate core layer.

20. The vehicle trim panel of claim 19, wherein cover shell layer has a higher surface quality than the cover core layer.
